(19) United States
(12) Patent Application Publication
(10) Pub. No.: US 2004/0020749 A1
(43) Pub. Date: Feb. 5, 2004

(54) Spiral immersion conveyor system, and method for use

(76) Inventors: Brian Wood, Lubbock, TX (US); Robin Roselli, Lubbock, TX (US); Chris Wilson, Lubbock, TX (US)

Correspondence Address: Raymond M Galasso, Simon Galasso & Frantz, P O Box 26503, Austin, TX, 78755-0503, US

(21) Appl. No.: 10/363,796

(22) PCT Filed: Sep. 14, 2001
(86) PCT No.: PCT/US01/29046

(51) Int. Cl. F25D 25/04; B65G 13/02; B65G 21/18

(52) U.S. Cl. 198/778; 62/380

(57) ABSTRACT

An improved method of transporting materials or products for chilling or freezing comprising the use of a multi-tiered, spiral path conveyor belt capable of tight radial turning in a restricted area to immerse the materials or products into a tank containing a cooling fluid and circulating the cooling fluid past the material or product is presented. The materials or products may or may not undergo chemical preparation prior to immersion, depending on the type of materials or products to be chilled or frozen. The cooling fluid, which can be food-grade solute, is circulated past the material at a substantially constant predetermined velocity and temperature to freeze the material or product. The cooling fluid is preferably between −20 degrees centigrade and −30 degrees centigrade, and the velocity of the cooling fluid past the material is about 35 liters per minute per foot of cooling fluid through an area not greater than about 24 inches wide and 48 inches deep. Alternatively, the speed of the multi-tiered, spiral path conveyor belt can be adjusted to increase or decrease the rate of immersion of the materials or products into the cooling fluid. All components of the multi-tiered, spiral path conveyor belt can be constructed of food-grade plastics.

### CROSS REFERENCE TO RELATED APPLICATIONS

This application claims benefit under 35 U.S.C. §119 of U.S. provisional patent application Serial No. 60/232,748, entitled Supachill Spiral Immersion Conveyor, which was filed on Sep. 15, 2000.

### FIELD OF THE INVENTION

The present invention relates generally to methods for transporting materials or products for processing, and more particularly to spiral immersion conveyor systems.

### BACKGROUND OF THE INVENTION

Automation of processes on an industrial scale was actualized on a large scale when Henry Ford pioneered the use of powered conveyor systems in automobile assembly lines in 1913. The evolution of automation has been such that to date the ability to convey materials on an uninterrupted basis through various processing stages has become mandatory for efficient, cost-effective operations in a wide variety of industrial applications ranging from automobile assembly to food processing. Conveyors employed in processing range from simple, unpowered roller systems to more complex electric or hydraulic powered systems in which materials are carried along by belt, bucket, screw, rack, or blower.

The freezing or chilling requirement of food processing has traditionally been achieved by stacking products to be chilled or frozen into large racks in refrigerated rooms so as to subject the product to large amounts of low temperature air “blasted” by fans over the product. Alternatively, product has bees placed between low temperature metal plates until the product is frozen. However, neither of these methods allow the continuous throughput of product through the chilling or freezing processes.

In other conventional methods, product is conveyed by a flat belt conveyor through a tunnel in which ultra-low temperature liquid nitrogen or carbon dioxide is sprayed over the product to freeze it. This method is limited to a single-level flat which typically requires a great deal of floor space, and often results in freezing the product to the conveyor belt. Ultra-low temperature liquid nitrogen and carbon dioxide have also been known to damage and “burn” raw, unpackaged product.

Another commonly used technique utilizes a conveyor configured to vertically transport product through an enclosed housing which contains blasted, low-temperature air. A significant limitation of these vertical freezers is that they have a relatively large footprint, and are therefore unsuitable for small-area applications.

### SUMMARY OF THE INVENTION

Therefore, what is needed is an improved method of transporting materials or products for freezing or chilling that avoids some of the problems inherent in currently available methods. Accordingly, at least one embodiment of the present invention provides an apparatus comprising at least one tank capable of holding a fluid, at least one circulator for circulating said fluid within the tank, and at least one conveyor. The conveyor is capable of transporting at least one item in a spiral path through the fluid. In at least one embodiment, the conveyor includes a conveyor belt comprised of individual, expandable flites made of food-grade plastic that allow the conveyor belt to make tight radius turns, and withstand temperature extremes. In various embodiments, the spiral path is a multi-tiered spiral path that carries product down into and up out of a cooling fluid with a temperature and circulation rate that allow rapid, controlled cooling of product carried through the tank by the spiral conveyor.

At least one embodiment of the present invention further provides a conveyor comprising at least one conveyor belt having a plurality of belt flites, at least one internal drive support capable of supporting the conveyor belt at a plurality of points along a spiral path, and at least one drive chain for driving the belt flites of the conveyor belt along the spiral path. The conveyor also includes at least one drive unit capable of driving the drive chain at a constant, designated speed throughout the length or path of the conveyor. In at least one embodiment, the conveyor belt comprises individual, expandable flites made of food-grade plastic that allow the conveyor belt to make tight radius turns, and withstand temperature extremes. In various embodiments, the spiral path is a multi-tiered spiral path that carries product down into and up out of a cooling fluid with a temperature and circulation rate that allow rapid, controlled cooling of product carried through the tank by the spiral conveyor.

Yet another embodiment of the present invention provides a method comprising placing at least one item having an initial temperature on a conveyor. The conveyor comprises a conveyor belt having a plurality of belt flites. The method further includes conveying the item through a tank of fluid in a spiral path, and controlling the speed of the conveyor belt so that the item remains in the fluid long enough to change the initial temperature of the at least one item by a desired amount. In at least one embodiment, the conveyor belt comprises individual, expandable flites made of food-grade plastic that allow the conveyor belt to make tight radius turns, and withstand temperature extremes. In various embodiments, the spiral path is a multi-tiered spiral path that carries product down into and up out of a cooling fluid with a temperature and circulation rate that allow rapid cooling of product carried through the tank by the spiral conveyor.

An object of at least one embodiment of the present invention is to convey materials or products in an efficient manner through a fluid to chill or freeze the materials or products.

An advantage of at least one embodiment of the present invention is the small footprint afforded due to the use of a multi-tiered spiral path conveyor for transport of materials or product.

A further advantage of at least one embodiment of the present invention is that each flite of the spiral conveyor path is an individual, separate unit to facilitate speed and ease of replacement without requiring dismantling of the conveyor or affecting other components, thus minimizing adverse impact on production throughput schedules.

An additional advantage of at least one embodiment of the present invention is that the method is an energy efficient, non labor intensive means to achieve fast throughput for freezing or chilling materials or products.

A further advantage of at least one embodiment of the present invention is that cooling is accomplished more rapidly than by many conventional methods.

A further advantage of at least one embodiment of the present invention is that sensitive or delicate substances can be frozen with no damage to the substance.

A further advantage of at least one embodiment of the present invention is that the spiral conveyor is capable of operating and maintaining a constant conveyor speed with a considerably reduced turning radius, thereby providing an advantage of creating a spiral conveyor within a reduced size configuration, being therefore effective in small operational areas.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a side view of a spiral conveyance apparatus used to transport materials or products through a tank of cooling fluid according to at least one embodiment of the present invention;

FIG. 2 is an illustration of a responsive belt flite according to an embodiment of the present invention;

FIG. 3 is a perspective view showing two of the responsive belt flites of FIG. 2, the belt flites are shown fitted together and clipped to a section of a flite drive chain, according to an embodiment of the present invention;

FIG. 4 is an end view of the belt flites and drive chain shown in FIG. 3;

FIG. 5 is an underside view of three flite drive chain sections enmeshed into the side of a horizontal internal driving sprocket;

FIG. 6 is a cut-away perspective view of a drive chain guide track mechanism guiding a section of a conveyor belt according to one embodiment of the present;

FIG. 7 is a perspective view of a spiral conveyance apparatus incorporating a mesh guard according to at least one embodiment of the present invention;

FIG. 8 is a cut-away side view of a chilling apparatus suitable for practicing a method according to at least one embodiment of the present invention;

FIG. 9 is side view of a spiral conveyance apparatus of FIG. 1 shown installed in the chilling apparatus illustrated in FIG. 8;

FIG. 10 is a flow diagram illustrating a method according to at least one embodiment of the present invention.

### DETAILED DESCRIPTION OF A PREFERRED EMBODIMENT OF THE INVENTION

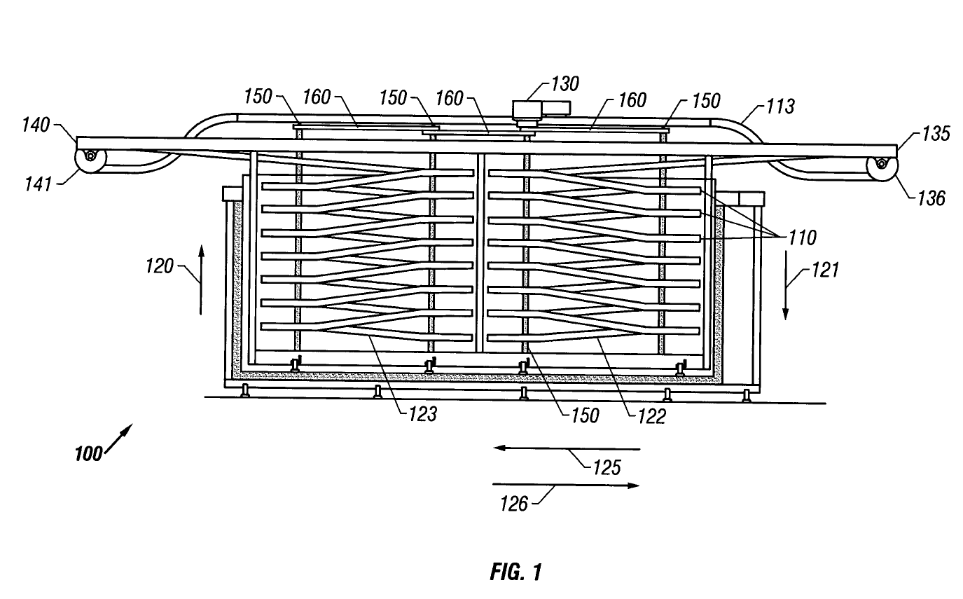

Referring first to FIG. 1, a side view of an spiral conveyance apparatus used to transport materials or products through a tank of cooling fluid according to at least one embodiment of the present invention is discussed, and designated generally as a spiral conveyor 100. Spiral conveyor 100 preferably comprises conveyor belt 110 configured such that a point on conveyor belt 110 located initially at input feed 135 moves down spiral path 122, up spiral path 123 and back to input feed 135 along return path 113. In the illustrated embodiment, spiral conveyor 100 also includes drive unit 130 for rotating supports 150 using tension belts 160, input feed 135 and output feed 140 for receiving and delivering items into and out of the spiral path, and idle internal support sprockets 136 and 141 for changing the path of conveyor belt 110 from the horizontal to the vertical plane.

Spiral conveyor 100 is preferably configured in a multi-tiered spiral, and may include any suitable number of spirals desired. One may choose the number of spirals and the spiral's diameter based on application parameters such as the size of the “footprint” needed for a particular application, the size of the items placed on conveyor belt 110, the length across which items are to be moved, the depth of a container (not shown) in which spiral conveyor 100 may be placed, the desired time of conveyance, and/or other similar considerations.

In at least one embodiment, conveyor belt 110 comprises a series of responsive expanding belt flites having a width which makes them capable of transporting materials or products through a series of 180 degree turns within an area of not more than about 620 millimeters. The preferred width of the responsive expanding flites is approximately 24 centimeters, but other flite widths can be employed effectively in various situations. The length of the responsive belt flites, is preferably chosen to based on the belt flite width that is used in a particular application. It will be appreciated that belt flite length, width, etc., may be custom-configured to optimally complement a desired tank size, and that other suitable configurations of conveyor belt 110 may be employed consistent with the principles set forth herein.

In the illustrated embodiment, drive unit 130 is coupled directly to one of supports 150, and rotates the remaining supports 150 through use of tension belts 160. It will be appreciated that other drive configurations may be employed consistent with the objectives of the present invention. For example, drive unit 130 need not be directly coupled to one of supports 150; various gear, chain and/or pulley combinations may be employed in place of tension belts 160; individual motors can be used to drive each support 150, thereby eliminating the need for tension belts 160; or other suitable substitutions may be made by those skilled in the art. Supports 150 cooperate with tension belts 160 and drive unit 130, to move conveyor belt 110 in vertical planes 120 and 121, as well as horizontal planes 125 and 126.

In a preferred embodiment, drive unit 130 is a frequency controlled drive used to ensure that the movement of materials or products traveling on conveyor belt 110 is maintained at a constant rate. It will be appreciated that other suitable types of drives, motors, etc. may be employed consistent with the teachings set forth herein. In the case where spiral conveyor 100 is used in conjunction with a liquid cooling system, maintaining the rate of movement of conveyor belt 110 at a constant rate helps to keep items being carried on conveyor belt 110 immersed within the cooling fluid no longer than is necessary to change the initial temperature of the materials or products by a desired amount. Another embodiment of the present invention incorporates a combination of multi-tiered, spiral path conveyor belt speed adjustment and cooling fluid circulation adjustment individually or separately in related combinations for the spiral conveyor 100 and cooling apparatus (not shown).

In one embodiment of the present invention, the path through which conveyor belt 110 moves comprises a downward spiral 122 and an upward spiral 123. Downward spiral 122 moves materials or products in a downward direction into a cooling fluid, whilst upward spiral 123 moves products or materials in an upward direction out of a cooling fluid. Note that the direction of conveyor belt 110 may be reversed without departing from the spirit and scope of the present invention. In that case, the direction of downward spiral 122 and upward spiral 123 are also reversed, as are the functions of input feed 135 and output feed 140.

It will also be appreciated that although FIG. 1 illustrates input feed 135 and output feed 140 as being at approximately the same vertical height, various embodiments of the present invention can be practiced in which input feed 135 and output feed 140 are at different vertical heights, and the downward spiral 122 and upward spiral 123 employ different numbers of turns to accommodate various production line configurations if desired. Note also that input feed 135 and output feed 140 need not be exactly opposite each other, thereby allowing conveyor 100 to move product in a non-straight line manner if so desired.

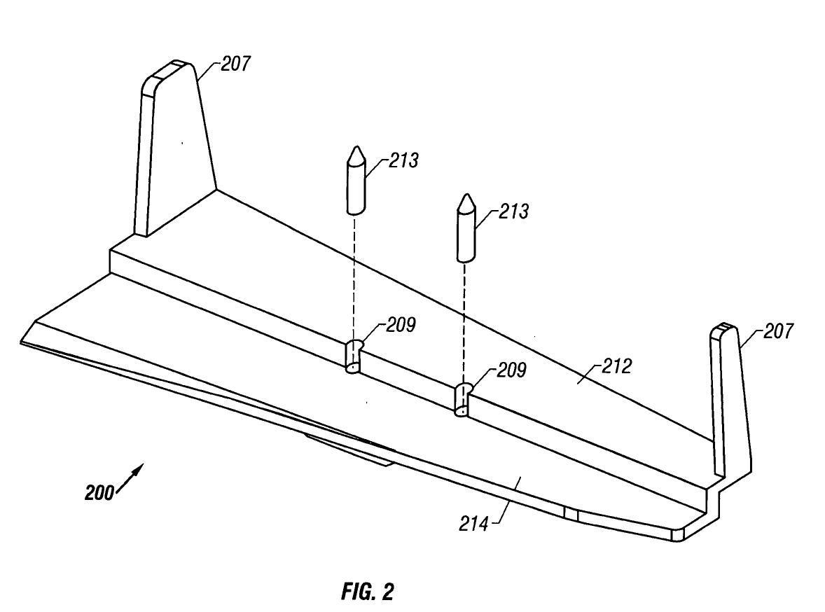

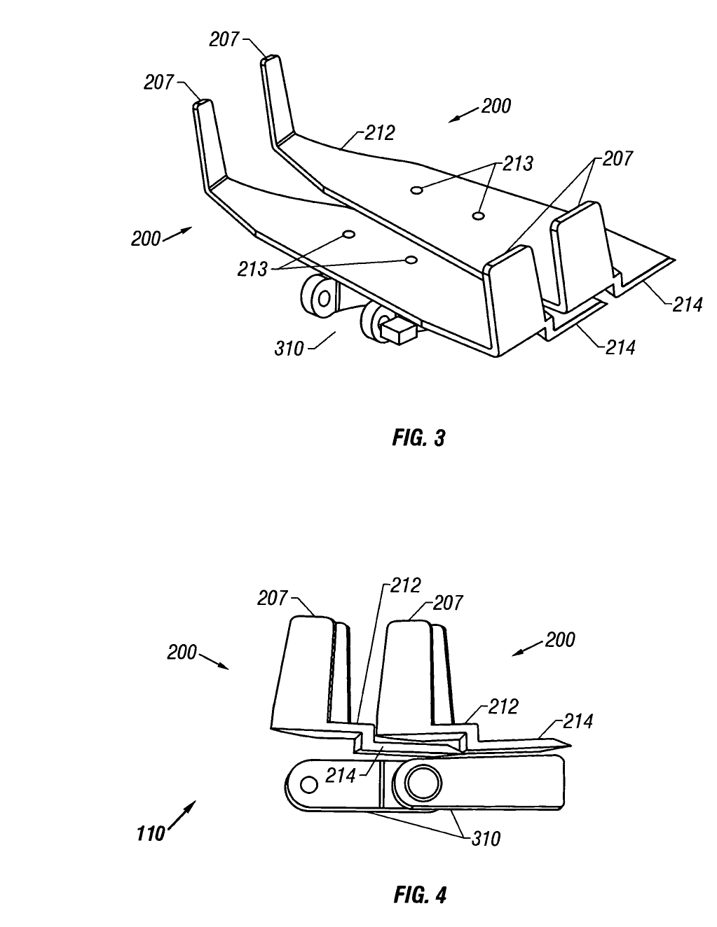

Referring now to FIGS. 2 and 3, an individual responsive expanding belt flite 200 according to at least one embodiment of the present invention is discussed. Conveyor belt 110 (FIG. 1) is preferably a collection of individual responsive expanding belt flites 200 arranged next to each other to achieve a continuous moving overlap of adjacent flites during forward travel of conveyor belt 110 (FIG. 1). In at least one embodiment, each individual responsive expanding belt flite 200 comprises an upper plate 212 having holes formed therein for receiving removable, molded pins 213, and molded wings 207. Both pins 213 and wings 207 assist in keeping product in place during travel of conveyor belt 110 (FIG. 1)

In addition to upper plate 212, flite 200 includes a lower plate 214 coupled together with upper plate 212 such that the two plates are free to slide in relationship to each other. In other embodiments, upper plate 212 and lower plate 214 are a molded or otherwise formed into a single element, and therefore upper plate 212 and lower plate 214 do not slide in relationship to each other. In such an embodiment, the individual belt flites 200 are still free to move in relation to each other. By allowing individual belt flites and/or upper plate 212 and lower plate 214 to slide in relationship to each other, when conveyor belt 110 (FIG. 1) moves into a 180 degree turn, upper plate 212 of each flite overlaps lower plate 214 of the flite immediately to the rear of that flite, while lower plate 214 of the flite in question is overlapped by upper plate 212 of the flight immediately preceding that flite. It will be appreciated that lower plate 214 may slide either forward or backward in relationship with upper plate 212.

This is illustrated in FIG. 3, which shows two individual responsive belt flites fitted together and clipped to drive chain link 310. When conveyor belt 110 (FIG. 1) moves through a non-curved portion of a path, lower plate 214 slides under upper plate 212 either partially or totally. In effect, the lower plate 214 automatically fans open or closed to provide a constant platform for product transport whether the flite is on a straight section or on a 180 degree corner. Although when operating in continuous series, a moving belt for product transport is formed, all responsive expanding belt flites 200 remain as individual, separate units as shown in FIG. 2A. Each flite of the belt 110 is therefore able to be changed or removed without impacting other components and without requiring that the conveyor be dismantled to effect maintenance.

Referring now to FIG. 4, an end view of two responsive belt flites 200 and their respective individual flite drive chain links 310 are shown. In at least one embodiment of the present invention, belt flites 200 are clipped to drive chain links 310 by snapping a clip (not shown) molded onto belt flites 200 onto a clip receptacle (not shown) formed on drive chain links 310. In other embodiments, belt flites 200 are pinned, screwed or otherwise fastened to individual links 310. All of the preferred embodiments provide the ability to remove individual belt flites 200 without requiring disassembly of the entire conveyor belt 110. In one embodiment, an individual belt flite 200 may be molded to an individual drive chain link 310, such that an entire link-flite assembly is replaced.

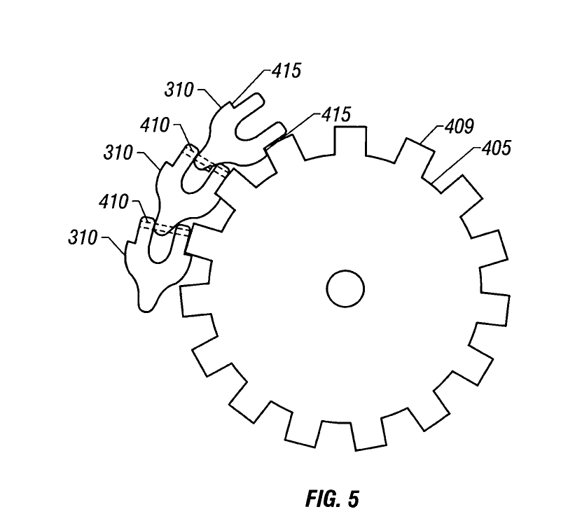

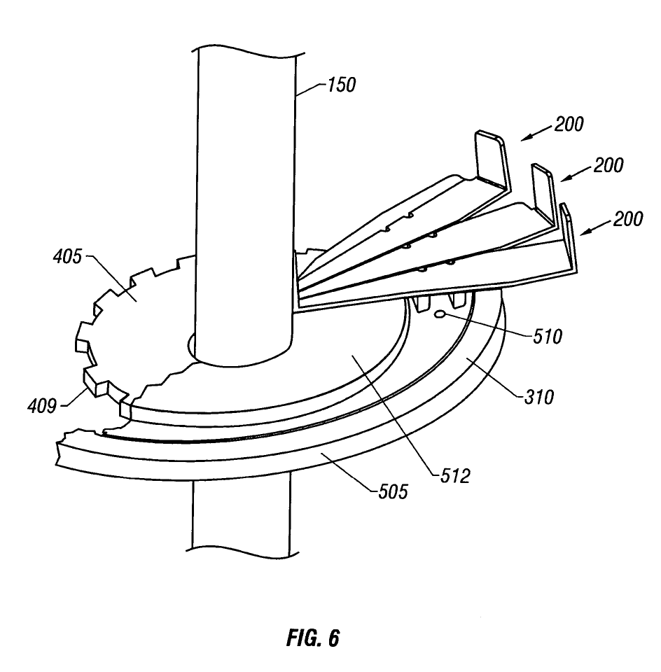

Referring now to FIG. 5, an underside view of three flite drive chain sections 310 (FIG. 4) enmeshed into the side of an horizontal internal driving sprocket 405 is illustrated. Reference numerals in FIG. 5 that are like, similar or identical to reference numerals in in FIGS. 1-4 indicate like, similar, or identical elements. In the illustrated embodiment, individual drive chain links 310 are connected by pins 410, as is in conventional chain construction. Movement of the flite drive chain section s 310 is accomplished when protrusions 415 formed on drive chain links 310 engage teeth 409 of driving sprocket 405. When driving sprocket 405 turns, teeth 409 move drive chain links 310, thereby moving flites 200 (FIG. 2A) attached to drive chain links 310. Note that drive chain links 310 have protrusions 415 formed on opposite sides. This allows drive chain links to be driven from either side.

In a preferred embodiment of the present invention, internal horizontal driving sprocket 405, drive chain links 310, pins 410, flites 200 (FIG. 3), and other components to be immersed, are all constructed of food-grade plastics to minimize the effects of repeated immersion in extremely cold fluid. This does not, however, preclude the use of other suitable materials for components in other embodiments of the present invention.

Referring now to FIGS. 1 and 6, a drive chain track mechanism 505 will be discussed. Reference numerals in FIG. 6 which are like, similar or identical to reference numerals in FIGS. 1-4 indicate like, similar or identical elements. Recall from the discussion of FIG. 1 that conveyor belt 110, comprised of a plurality of individual responsive flites 200, is moved through a spiral path having a plurality of supports 150. In a preferred embodiment, conveyor belt 110 is guided around supports 150 by use of drive chain track mechanism 505. A drive chain track mechanism 505 is mounted on each support 150 at the point where conveyor belt 110 makes a turn. So, for example, if conveyor belt 110 makes seven turns around one support 150, then that support will have seven drive chain track mechanisms 505 mounted thereon.

Drive chain track mechanism 505 has track 510 formed therein for receiving drive chain links 310. Slot 512 is formed on the inner diameter of track 510 to allow teeth 409 of driving sprocket 405 to engage protrusions 415 (FIG. 5) of drive chain 310. As noted earlier, responsive belt flites 200 are fastened to flite drive chain links 310 which are guided around support 150 by track 510, thereby allowing conveyor belt 110 to form a multi-layered spiral. It will be appreciated that other suitable-drive configurations may be employed consistent with the teachings set forth herein.

Most components of the spiral conveyor 100, including drive chain track mechanism 505, can be manufactured from food-grade plastics to specifications that allow successful operation at temperatures to −30 degrees centigrade while continuously traveling at a controlled speed during immersion in a chilling fluid. Other embodiments, however, use materials other than plastic, such as Teflon, to form the flites 200 or other portions of spiral conveyor 100.

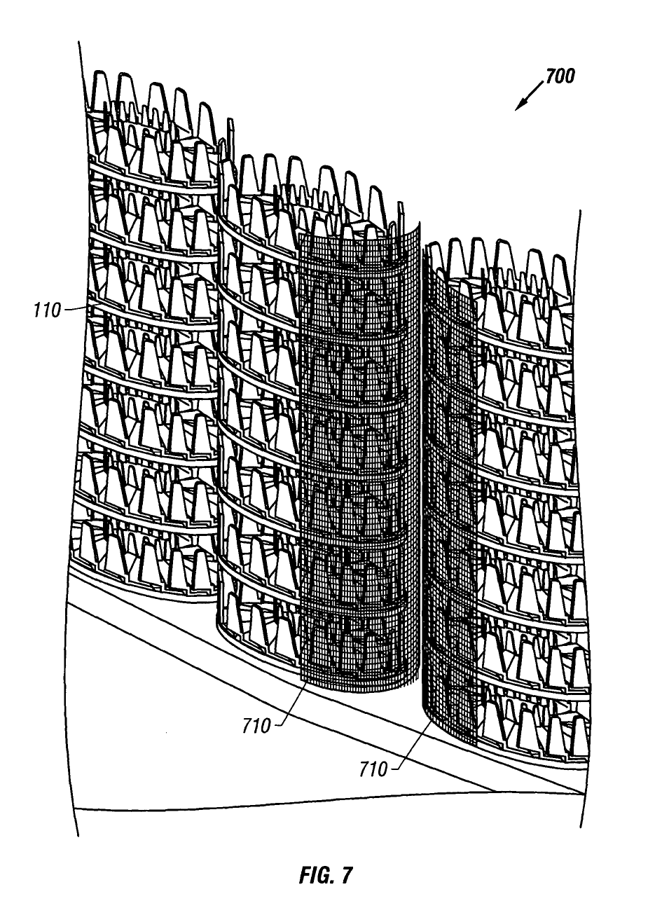

Referring now to FIG. 7, another depiction of the spiral conveyance apparatus used to transport materials or products according to at least one embodiment of the present invention is discussed. Reference numerals in FIG. 7 that are like, similar, or identical to reference numerals in FIGS. 1-6 indicate like, similar, or identical features. As previously noted, spiral conveyor 100 (FIG. 100) is preferably configured as a multi-tiered spiral. To contain materials or products during transport at the apex of the curved portion of a turn, spiral conveyor 100 may be fitted with mesh guards 710 as shown in FIG. 7. In the illustrated embodiment, mesh guards 710 are shown covering a seven-tier spiral conveyor, however, the height of mesh guards 710 is generally in proportion to the number of tiers employed for a particular configuration. It will be appreciated that mesh guards 710 need not be shaped exactly as pictured in FIG. 7, as long as the mesh guards 710 serve the desired purpose of material or product containment through a curve. At least one embodiment of the present invention provides for all components of the spiral conveyor 100, including mesh guards 710, to be manufactured from food-grade plastics. This does not, however, exclude other embodiments wherein the components can be manufactured from other suitable materials.

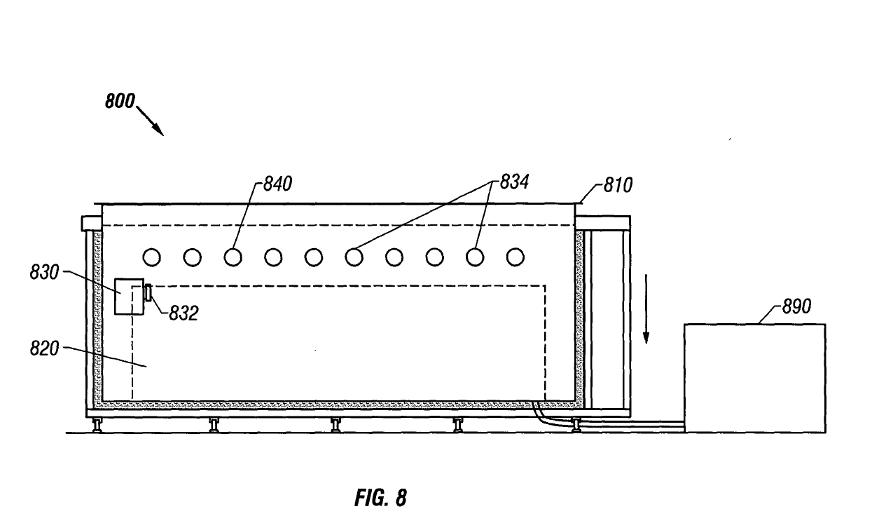

Referring next to FIG. 8, a chilling apparatus suitable for use with spiral conveyor 100 (FIG. 1) is illustrated according to at least one embodiment of the present invention, and designated generally as cooling unit 800. Note that the chilling apparatus is shown without spiral conveyor 100 for ease of illustration and clarity of description. Cooling unit 800 preferably comprises tank 810 containing cooling fluid 840. Submersed in cooling fluid 840 are circulators 834 such as motors 830 having impellers 832, and heat exchanging coil 820. Material to be chilled may include, but is not limited to, food stuffs, viable single cells, tissues, nucleic acids, and other biologically active molecules. External to tank 810, and coupled to heat exchanging coil 820, is refrigeration unit 890.

Tank 810 may be of any dimensions necessary to immerse material to be frozen in a volume of cooling fluid 840, in which the dimensions are scaled multiples of 12 inches by 24 inches by 48 inches. Other size tanks may be employed consistent with the teachings set forth herein. For example, in one embodiment (not illustrated), tank 810 is sized to hold just enough cooling fluid 840, so containers can be placed in tank 810 for rapid freezing of suspensions including biological materials and cryoprotectants. In other embodiments, tank 810 is large enough to completely immerse entire organisms or large food products for rapid freezing. It will be appreciated that tank 810 can be made larger or smaller, as needed to efficiently accommodate various sizes and quantities of material to be frozen.

Tank 810 holds cooling fluid 840. In one embodiment, the cooling fluid is a food-grade solute. Good examples of food-grade quality fluids are those based on propylene glycol, sodium chloride solutions, or the like. In another embodiment, the cooling fluid is a cryoprotectant such as dimethylsulfoxide (DMSO), ethylene glycol, propylene glycol, polyethylene glycol or the like. In other embodiments, other fluids, and preferably solutes, are used as cooling fluids. While various containers may be used to hold the material or product, some embodiments of the present invention provide for the material or products to be directly immersed in the cooling fluid for rapid and effective freezing.

In order to freeze material while avoiding the formation of ice crystals, one embodiment of the present invention circulates cooling fluid 840 past the material to be frozen, at a relatively constant rate of 35 liters per minute for every foot of cooling fluid contained in an area not more than 24 inches wide by 48 inches deep. The necessary circulation is provided by one or more circulators 834, such as motors 830. In at least one embodiment of the present invention, submersed motors 830 drive impellers 832 to circulate cooling fluid 840 past material to be frozen. Other circulators 834, including various pumps (not illustrated), can be employed consistent with the objects of the present invention. At least one embodiment of the present invention increases the area and volume through which cooling fluid is circulated by employing at least one circulator 834 in addition to motors 830. In embodiments using multiple circulators 834, the area and volume of cooling fluid circulation are increased in direct proportion to each additional circulator employed. For example, in a preferred embodiment, one additional circulator is used for each foot of cooling fluid that is to be circulated through an area of not more than about 24 inches wide by 48 inches deep.

Preferably, motors 830 can be controlled to maintain a constant predetermined velocity of cooling fluid flow past the materials or products to be preserved, while at the same time maintaining an even distribution of cooling fluid temperature within +/−0.5° C. at all points within tank 810. The substantially constant predetermined velocity of cooling fluid circulating past the material or product provides a constant, measured removal of heat, which allows for the chilling or freezing of the material or product. In one embodiment, cooling fluid properties, such as viscosity, temperature, etc., are measured and processed, and control signals are sent to motors 830 to increase or decrease the rotational speed or torque of impellers 832 as needed. In other embodiments, motors 830 are constructed to maintain a given rotational velocity over a range of fluid conditions without producing additional heat. In such a case, the torque or rotational speed of impellers 832 imparted by motors 830 are not externally controlled. Of note is the fact that no external pumps, shafts, or pulleys are needed in the chilling apparatus. Motors 830, or other circulators 834, are immersed directly in cooling fluid 840. As a result, cooling fluid 840 not only freezes material placed in tank 810, but cooling fluid 840 also provides cooling for motors 830.

Heat exchanging coil 820 is preferably a “multi-path coil,” which allows refrigerant to travel through multiple paths (i.e. three or more paths), in contrast to conventional refrigeration coils in which refrigerant is generally restricted to one or two continuous paths. In addition, the coil size is in direct relationship to the cross sectional area containing the measured amount of the cooling fluid 840. For example, in a preferred embodiment, tank 810 is one foot long, two feet deep and four feet wide, and uses a heat exchanging coil 820 that is one foot by two feet. If the length of tank 810 is increased to twenty feet, then the length of heat exchanging coil 820 is also increased to twenty feet. As a result, heat exchanging coil 820 can be made approximately fifty percent of the size of a conventional coil required to handle the same heat load. Circulators 834 such as motors 830, circulate chilled cooling fluid 840 over material to be frozen, and then transport warmer cooling fluid to heat exchanging coil 820, which is submersed in cooling fluid 840. In at least one embodiment, heat exchanging coil 820 is so designed to remove not less than the same amount of heat from cooling fluid 840 as that removed from the material being frozen, thereby maintaining the temperature of cooling fluid 840 in a predetermined range. Heat exchanging coil 820 is connected to refrigeration unit 890, which removes the heat from heat exchanging coil 820 and the system.

In a preferred embodiment, refrigeration unit 890 is designed to match the load requirement of heat exchanging coil 820, so that heat is removed from the system in a balanced and efficient manner, resulting in the controlled, rapid freezing of a material. The efficiency of the refrigeration unit 890 is directly related to the method employed for controlling suction pressures by the efficient feeding of the heat exchange coil 820 and the efficient output of compressors used in refrigeration unit 890.

This methodology requires very close tolerances to be maintained between the refrigerant and cooling fluid 840 temperatures, and between the condensing temperature and the ambient temperature. These temperature criteria, together with the design of the heat exchange coil 820, allows heat exchange coil 820 to be fed more efficiently, which in turn allows the compressor to be fed in a balanced and tightly controlled manner to achieve in excess of twenty-five percent greater performance from the compressors than that which is accepted as the compressor manufacturer's standard rating.

Note that in the embodiment illustrated in FIG. 8, refrigeration unit 890 is an external, remotely located refrigeration system. However, in another embodiment (not illustrated), refrigeration unit 890 is incorporated into another section of tank 810. It will be appreciated that various configurations for refrigeration unit 890 may be more or less appropriate for certain configurations of cooling unit 800. For example, if tank 810 is extremely large, a separate refrigeration unit 890 may be desirable, while a portable embodiment may benefit from an integrated refrigeration unit 890. Such an integration is only made possible by the efficiencies achieved by implementing the principles as set forth herein, and particularly the use of a reduced-size heat exchanging coil.

By virtue of refrigeration unit 890 and heat exchanging coil 820, in a preferred embodiment, the cooling fluid is cooled to a temperature of between −20° C. and −30° C., with a temperature differential throughout the cooling fluid of less than about +/−0.5° C. In other embodiments, the cooling fluid is cooled to temperatures outside the −20° C. to −30° C. range in order to control the rate at which a substance is to be frozen. Other embodiments control the circulation rate of the cooling fluid to achieve desired freezing rates. Alternatively, the volume of cooling fluid may be changed in order to facilitate a particular freezing rate. It will be appreciated that various combinations of cooling fluid circulation rate, cooling fluid volume, and cooling fluid temperature can be used to achieve desired freezing rates.

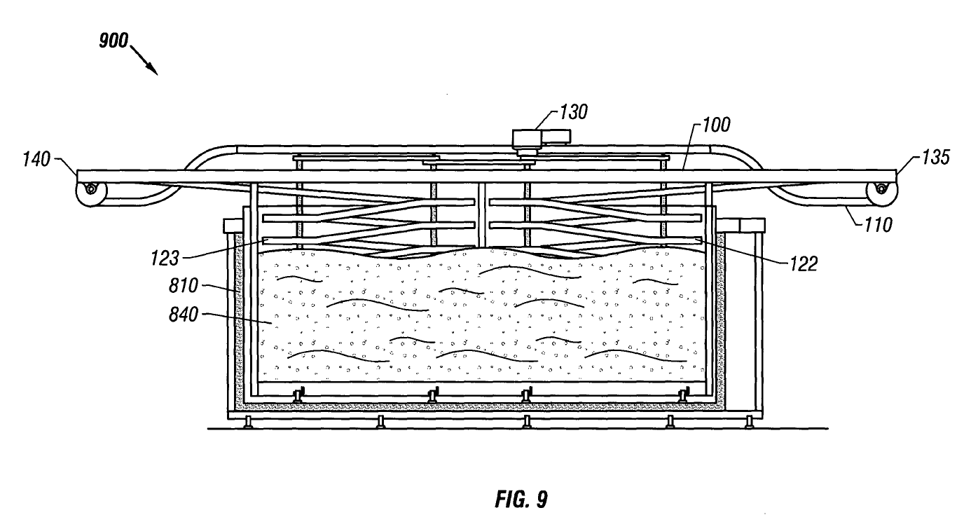

Referring now to FIG. 9, a system comprising spiral conveyor 100 and cooling system 800 (FIG. 8) is illustrated and designated generally as system 900. Reference numerals in FIG. 9 that are like, similar or identical to reference numerals in FIGS. 1-8 indicate like, similar or identical features. In a preferred embodiment, system 900 is used for conveying relatively large quantities of material for freezing or chilling. Tank 810 contains cooling fluid 840, into which multi-tiered spiral conveyor 100 is placed for operation.

In use, once the cooling fluid 840 is chilled to a desired temperature, materials or products to be frozen are fed into the input feed 135 where they are taken onto conveyor belt 110. As previously discussed, conveyor belt 110 comprises belt flites 200 (FIG. 2), which are driven by the multi-link drive chain 310 in order to transport an item to be frozen through cooling fluid 840. The item travels from input feed 135, into the cooling fluid 840 on downward spiral 122, out of the cooling fluid 840 on upward spiral 123, and out of spiral conveyor 100 at output feed 140.

As noted earlier, the cooling fluid is preferably kept at a constant predetermined temperature, and circulated at a rate that ensures rapid, safe freezing of items to be frozen. The time the item spends submerged in cooling fluid 840 can be varied by adjusting drive unit 130, or by other suitable means. Ideally, the speed of conveyor belt 110, in combination with the temperature and circulation rate of cooling fluid 840, will be adjusted so that exactly the desired amount of heat will be removed from items as they travel through tank 810 on spiral conveyor 100.

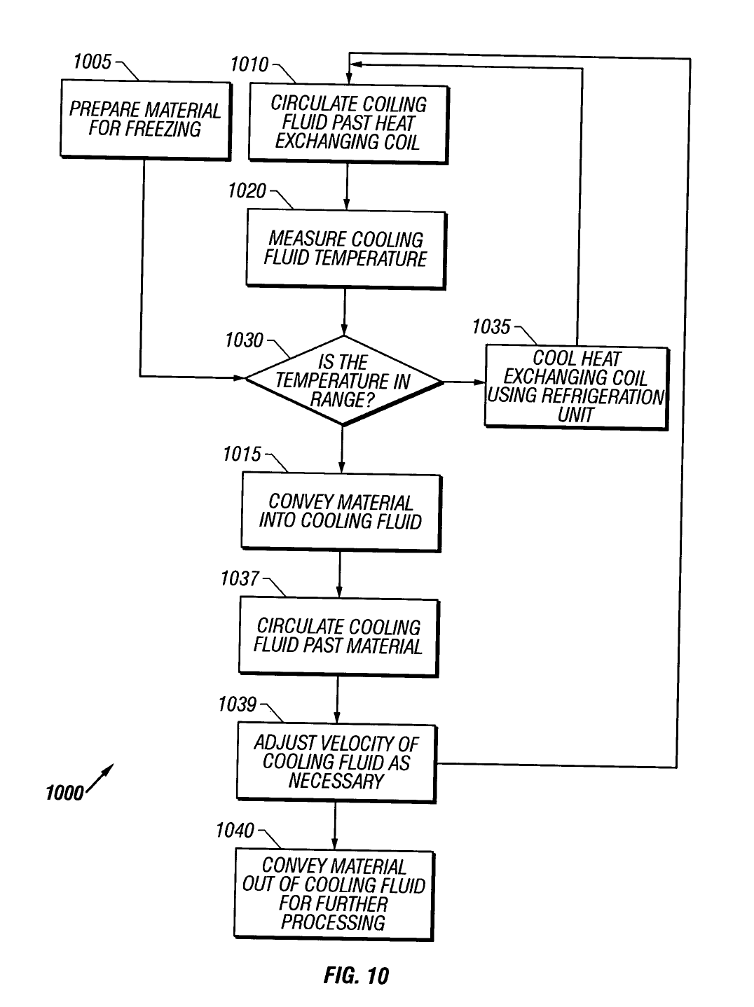

Referring now to FIG. 10, a method according to one embodiment of the present invention is illustrated, and designated generally by reference numeral 1000. The illustrated method begins at step 1010, where cooling fluid is circulated past a heat exchange coil. The heat exchange coil is operably coupled to a refrigeration system as discussed above, and is used to reduce the temperature of the cooling fluid as the cooling fluid is circulated past the heat exchange coil. In step 1020, the temperature of the cooling fluid is measured, and the method proceeds to step 1030 where it is determined whether the temperature of the cooling fluid is within an optimal temperature range. This optimal cooling fluid temperature range may be different for different applications, however, a preferred optimal temperature range for many applications is between −20° C. and −30° C.

If the cooling fluid temperature is determined not to be within an optimal, predetermined temperature range, step 1035 is performed. In step 1035, the heat exchanging coil is cooled by a refrigeration unit, and the method returns to step 1010, in which the cooling fluid is circulated past the heat exchange coil in order to lower the temperature of the cooling fluid. Preferably, steps 1010, 1020, 1030 and 1035 are performed continually until the cooling fluid reaches the optimal temperature range.

The temperature of the cooling fluid used to freeze the materials or products is an important element of at least one embodiment of the present invention. While the cooling fluid is being cooled to the proper temperature, materials to be frozen are prepared for freezing in step 1005. The preparation may be fairly minimal where foodstuffs are to be frozen. Alternatively, certain biological materials may require chemical preparation prior to freezing. Chemically preparing the material may include pretreatment of the material with agents (stabilizers) that increase cellular viability by removing harmful substances secreted by the cells during growth or cell death. Many food products do not require chemical preparation. Useful stabilizers include those chemicals and chemical compounds, many of which are known to those skilled in the art, which sequester highly reactive and damaging molecules such as oxygen radicals.

After the cooling fluid reaches a proper temperature, step 1015 is performed, in which the materials or products are conveyed for immersion in the cooling fluid. As noted earlier, the material may be held in a container, or placed directly into the cooling fluid. The method then proceeds to step 1037, in which a circulator, such as a submersed motor/impeller assembly or pump, is used to circulate the cooling fluid at the velocity previously discussed, past the immersed material. As the cooling fluid passes by the material, heat is removed from the material, which is at a higher temperature than the temperature of the cooling fluid, and is transferred to the cooling fluid, which transports the heat away from the material to be frozen. According to at least one embodiment of the present invention, a substantially constant circulation of cooling fluid past the material to be frozen should be maintained in order to freeze the materials or products such that the materials or products are vitrified.

After the cooling fluid is circulated past the material to be frozen, step 1039 is performed. Step 1039 adjusts the velocity of the cooling fluid as necessary to account for changes in the cooling fluid viscosity, temperature, and the like. Preferably, the velocity of the cooling fluid is held constant by adjusting the force provided by one or more circulators. After appropriate parameters have been adjusted and the conveyed materials have reached the desired temperature, in step 1040 the materials are conveyed from the cooling fluid 840 by the multi-tiered, spiral path immersion conveyor 100 for further processing.

In an alternate example of a preferred embodiment, the speed of the multi-tiered, spiral path conveyor belt can be made adjustable by controls (not illustrated) to insure that the materials or products traveling along the conveyor belt remain immersed within the cooling fluid no longer than is necessary to change the initial temperature of the materials or products by a desired amount. An additional embodiment to the method would incorporate a combination of multi-tiered, spiral path conveyor belt speed adjustment and cooling fluid circulation adjustment individually or in an interrelated combination for the conveyance system and cooling apparatus to maximize the cooling efficiency and throughput of the method as presented.

The steps illustrated in FIG. 10 are shown and discussed in a sequential order. However, the illustrated method is of a nature wherein some or all of the steps are continuously performed, and may be performed in a different order. For example, at least one embodiment of the present invention uses a single circulating motor to circulate the cooling fluid. In such an embodiment, cooling fluid is circulated past a heat exchanging coil as in step 1010 and past the material to be preserved in step 1037 at the same time. In addition, one embodiment of the present invention measures cooling fluid temperatures, viscosities, and other fluid properties continually, and at multiple locations within the system.

In yet another embodiment, some properties of the cooling fluid are not directly measured. Rather, the change in cooling fluid properties is determined indirectly from the rotational speed of a circulation motor. If the motor is turning at a slower rate, then additional power can be supplied to the motor to return the motor to the desired rotational speed, thereby compensating for the change in cooling fluid properties. In at least one embodiment, a motor is configured to maintain a substantially constant rate of rotation. This substantially constant rate of motor rotation will result in a substantially constant rate of cooling fluid circulation.

In the preceding detailed description, reference has been made to the accompanying drawings which form a part hereof, and in which are shown by way of illustration specific embodiments in which the invention may be practiced. These embodiments have been described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description omits certain information known to those skilled in the art. The preceding detailed description is, therefore, not to be taken in a limiting sense, and the scope of the present invention is defined only by the appended claims.

What is claimed is:

1. An apparatus comprising:
at least one tank, said tank capable of holding a fluid;
at least one circulator, said circulator capable of circulating said fluid within said tank; and
at least one conveyor, said conveyor capable of transporting at least one item in a spiral path through said fluid;

2. The apparatus as in claim 1, wherein said spiral path is a multi-tiered spiral path.

3. The apparatus as in claim 1, wherein a first portion of said conveyor moves said at least one item downward within said tank, and a second portion of said conveyor moves said at least one item upward within said tank.

4. The apparatus as in claim 3, wherein said conveyor moves said at least one item horizontally within said tank.

5. The apparatus as in claim 1, wherein said conveyor comprises:
a conveyor belt having a plurality of belt flites;
at least one support capable of supporting said conveyor at a plurality of points along said spiral path;
one or more drive chains, said one or more drive chains capable of driving said belt flites of said conveyor belt along said spiral path; and
at least one drive unit, said drive unit capable of driving said one or more drive chains.

6. The apparatus as in claim 5, wherein said plurality of belt flites are arranged to continuously overlap adjacent belt flites during forward travel.

7. The apparatus as in claim 5, wherein each belt flight is individually replaceable.

8. The apparatus as in claim 5, wherein said belt flites include a side wing to contain said at least one item during movement of said conveyor belt.

9. The apparatus as in claim 5, wherein said belt flites are made of food-grade plastic.

10. The apparatus as in claim 5, wherein said support is made of food-grade plastic.

11. The apparatus as in claim 5, wherein said drive chain is made of food-grade plastic.

12. The apparatus as in claim 5, wherein said belt flites have a width of about 240 millimeters.

13. The apparatus as in claim 5, wherein:
said drive rotates said supports using one or more tension belts;
the rotation of said supports rotates a sprocket connected thereto; and wherein said sprocket drives said conveyor belt.

14. The apparatus as in claim 1, wherein said conveyor is capable of moving said at least one item through a 180° turn within an area of not more than about 620 millimeters.

15. The apparatus as in claim 1, wherein said circulator is capable of circulating said fluid at a substantially constant predetermined velocity.

16. The apparatus as in claim 1, wherein said circulator comprises:
a motor; and
an impeller rotatably coupled to the motor such that the impeller rotates to circulate the fluid.

17. The apparatus as in claim 1, further comprising a heat exchanging coil submersed in said fluid, said heat exchanging coil capable of removing at least the same amount of heat from said fluid as said fluid removes from said at least one item.

18. The apparatus as in claim 17, further comprising a refrigeration unit capable of substantially matching load requirements of the heat exchanging coil.

19. The apparatus in claim 1, wherein said fluid is a food-grade solute.

20. The apparatus as in claim 1, wherein the fluid is maintained at a temperature not colder than about −30 degrees centigrade.

21. The apparatus as in claim 1, wherein a speed of said conveyor can be controlled, such that the at least one item remains in the fluid long enough to change an initial temperature of the at least one item by a desired amount.

22. A conveyor comprising:
at least one conveyor belt having a plurality of belt flites;
at least one support capable of supporting said conveyor belt at a plurality of points along a spiral path;
at least one drive chain, said at least one drive chain capable of driving said belt flites of said conveyor belt along said spiral path; and
at least one drive unit, said drive unit capable of driving said at least one drive chain.

23. The conveyor as in claim 22, wherein said spiral path is a multi-tiered spiral path.

24. The conveyor as in claim 22, wherein said conveyor belt moves said at least one item downward along a first portion of said spiral path and upward along a second portion of said spiral path.

25. The conveyor as in claim 24, wherein said conveyor belt moves said at least one item horizontally.

26. The conveyor as in claim 22, wherein said plurality of belt flites are arranged to continuously overlap adjacent belt flites during forward travel.

27. The conveyor as in claim 22, wherein each belt flite is individually replaceable.

28. The conveyor as in claim 22, where said belt flites include a side wing to contain said at least one item during movement of said conveyor belt.

29. The conveyor as in claim 22, wherein said belt flites are made of food-grade plastic.

30. The conveyor as in claim 22, wherein said support is made of food-grade plastic.

31. The conveyor as in claim 22, wherein said at least one drive chain is made of food-grade plastic.

32. The conveyor as in claim 22, wherein said belt flites have a width of about 240 millimeters.

33. The conveyor as in claim 22, wherein said conveyor belt is capable of moving through a 180° turn within an area of not more than about 620 millimeters.

34. The conveyor as in claim 22, wherein:
said drive rotates said supports using one or more tension belts;
the rotation of said supports rotates a sprocket connected thereto; and wherein said sprocket drives said conveyor belt.

35. The conveyor in claim 22, wherein said drive unit comprises an electric motor.

36. The conveyor in claim 22, wherein the fluid is a food-grade solute.

37. The conveyor as in claim 22, wherein the fluid is maintained at a temperature not colder than about −30 degrees centigrade.

38. The conveyor as in claim 22, wherein a speed of said conveyor belt can be controlled, such that the at least one item remains in the fluid long enough to change an initial temperature of the at least one item by a desired amount.

39. A method comprising:
placing at least one item, the item having an initial temperature, on a conveyor, the conveyor comprising a conveyor belt having a plurality of belt flites;
conveying the at least one item through a tank of fluid in a spiral path;
controlling the speed of the conveyor belt, such that the at least one item remains in the fluid long enough to change the initial temperature of the at least one item by a desired amount.

40. The method as in claim 39, wherein the speed of the conveyor belt is controlled such that the at least one item remains in the fluid no longer than necessary to change the initial temperature of the at least one item by a desired amount.

41. The method as in claim 39, further comprising:
circulating the fluid past a heat exchanging coil submersed in the fluid; and wherein
the heat exchanging coil is capable of removing at least the same amount of heat from the cooling fluid as the amount of heat the fluid removes from the substance.

42. The method as in claim 41, further comprising cooling the heat exchanging coil with a refrigeration unit substantially matching load requirements of the heat exchanging coil.

43. The method as in claim 41, wherein the circulation rate is about 35 liters per minute per foot of fluid through an area not greater than about 24 inches wide and 48 inches deep.

44. The method as in claim 41, wherein the fluid is circulated using a motor and an impeller rotatably coupled to the motor.

45. The method as in claim 39, wherein the spiral path is a multi-tiered spiral path.

46. The method as in claim 39, wherein a first portion of the conveyor moves the at least one item downward within the tank, and a second portion of the conveyor moves the at least one item upward within the tank.

47. The method as in claim 46, wherein the conveyor moves the at least one item horizontally within the tank.

48. The method as in claim 39, wherein the conveyor further comprises:
at least one support capable of supporting the conveyor at a plurality of points along the spiral path;
one or more drive chains, the one or more drive chains capable of driving the belt flites of the conveyor belt along the spiral path; and
at least one drive unit, the drive unit capable of driving the one or more drive chains.

49. The method as in claim 48, wherein the drive chain is made of food-grade plastic.

50. The method as in claim 48, wherein the one or more drive chains rotate the supports, and the rotation of the supports drives the conveyor belt.

51. The method as in claim 39, wherein the plurality of belt flites are arranged to continuously overlap adjacent belt flites during forward travel.

52. The method as in claim 39, wherein each belt flite is individually replaceable.

53. The method as in claim 39, wherein the belt flites include a side wing to contain the at least one item during movement of the conveyor belt.

54. The method as in claim 39, wherein the belt flites are made of food-grade plastic.

55. The method as in claim 39, wherein the support is made of food-grade plastic.

56. The method as in claim 39, wherein the plurality of belt flites have widths of about 240 millimeters.

57. The method as in claim 39, wherein the conveyor is capable of moving the at least one item through a 180° turn within an area of not more than about 620 millimeters.

58. The method in claim 39, wherein the fluid is a food-grade solute.

59. The method as in claim 39, wherein the fluid is maintained at a temperature not colder than about −30 degrees centigrade.
